(19) United States
(12) Patent Application Publication
(10) Pub. No.: US 2016/0370519 A1
(43) Pub. Date: Dec. 22, 2016

(54) OPTICAL ELEMENT USING MULTI-LAYER FILM AND OPTICAL APPARATUS

(71) Applicant: CANON KABUSHIKI KAISHA, Tokyo (JP)

(72) Inventor: Daisuke Sano, Moka-shi (JP)

(21) Appl. No.: 15/181,713

(22) Filed: Jun. 14, 2016

(30) Foreign Application Priority Data
Jun. 18, 2015 (JP) 2015-122940

(51) Int. Cl. G02B 5/28; G02B 21/16

(52) U.S. Cl. CPC G02B 5/285; G02B 21/16

(57) ABSTRACT

An optical element 100 includes a multi-layer film formed by stacking a plurality of first and second film stacks 110 and 120 that are film stacks, where three or more films are stacked using two types of films made from materials having mutually different refractive indexes, and have different film configurations. Of the two types of films in the plurality of first and second film stacks, a film having a higher refractive index is an H-film and a film having a lower refractive index is an M-film. The H-film and the M-film of each of the first film stacks are stacked in the order of the H-film, the M-film and the H-film, and the H-film and the M-film of each of the second film stacks are stacked in the order of the M-film, the H-film and the M-film. The predetermined conditional expressions are satisfied.

### BACKGROUND OF THE INVENTION

### Field of the Invention

The present invention relates to an optical element such as an optical filter using a multi-layer film.

### Description of the Related Art

Multi-film layers have been used for various optical apparatuses as an antireflection film to increase a quantity of incident light incident on an image pickup optical system of a camera and a polarization separation film to selectively perform reflection and transmission according to a polarization direction of polarization incident on the optical system.

One of optical filters using multi-film layers is a minus filter that transmits light in a fundamental wavelength band and reflects light of part of a wavelength in other wavelength bands. Such a minus filter, for example, is used to switch an optical path of focused light onto a sample or reading light having a wavelength different from that of the focused light in a fluorescence microscope. Japanese Patent Laid-Open No. (“JP”) 2006-23471 discloses a minus filter that makes an average sum of optical thicknesses of high refractive index layers and low refractive index layers equal to a wavelength of incident light so as to decrease reflectance in part of a wavelength band.

However, in the minus filter disclosed in JP 2006-23471, since thickness of each thin film configuring a multi-layer film is extremely thick and the number of stacked layers of the films exceeds 100, total thickness of the multi-layer film is enormously as thick as about 20 μm. Thus, when the multi-layer film is actually used for optical apparatuses, problems such as a film crack due to stress concentration occur.

### SUMMARY OF THE INVENTION

The present invention provides an optical element capable of obtaining the same optical performance as a minus filter using a multi-layer film having comparatively thin thickness.

An optical element according to one aspect of the present invention includes a multi-layer film formed by stacking a plurality of first film stacks and second film stacks that are film stacks, where three or more films are stacked using two types of films respectively made from materials having mutually different refractive indexes, and have different film configurations. When, of the two types of films in the plurality of first and second film stacks, a film made from a material having a higher refractive index is an H-film and a film made from a material having a lower refractive index is an M-film, the H-film and the M-film of each of the first film stacks are stacked in the order of the H-film, the M-film and the H-film, and the H-film and the M-film of each of the second film stacks are stacked in the order of the M-film, the H-film and the M-film. The following conditional expression are satisfied:

$$\frac{2 {U}_{1 H} {U}_{1 M} tan {Δ}_{1 H} + {U}_{1 M}^{2} tan {Δ}_{1 M} - {U}_{1 H}^{2} {tan}^{2} {Δ}_{1 H} tan {Δ}_{1 M}}{2 {U}_{1 H} {U}_{1 M} tan {Δ}_{1 H} + {U}_{1 H}^{2} tan {Δ}_{1 M} - {U}_{1 M}^{2} {tan}^{2} {Δ}_{1 H} tan {Δ}_{1 M}} > 0$$

$$\frac{2 {U}_{2 H} {U}_{2 M} tan {Δ}_{2 H} + {U}_{2 M}^{2} tan {Δ}_{2 M} - {U}_{2 H}^{2} {tan}^{2} {Δ}_{2 H} tan {Δ}_{2 M}}{2 {U}_{2 H} {U}_{2 M} tan {Δ}_{2 H} + {U}_{2 H}^{2} tan {Δ}_{2 M} - {U}_{2 M}^{2} {tan}^{2} {Δ}_{2 H} tan {Δ}_{2 M}} > 0$$

$${U}_{1 H , 1 M , 2 H , 2 M} = {n}_{1 H , 1 M , 2 H , 2 M} cos {θ}_{1 H , 1 M , 2 H , 2 M}$$

$${Δ}_{1 H , 1 M , 2 H , 2 M} = \frac{2 π}{{λ}_{i}} {n}_{1 H , 1 M , 2 H , 2 M} {d}_{1 H , 1 M , 2 H , 2 M} cos {θ}_{1 H , 1 M , 2 H , 2 M} ,$$

where n_{1H} and d_{1H} are respectively a refractive index and physical thickness of the H-film of each of the first film stacks, θ_{1H} is a propagation angle of light in the H-film of each of the first film stacks, n_{1M} and d_{1M} are respectively a refractive index and physical thickness of the M-film of each of the first film stacks, θ_{1M} is a propagation angle of light in the M-film of each of the first film stacks, n_{2H} and d_{2H} are respectively a refractive index and physical thickness of the H-film of each of the second film stacks, θ_{2H} is a propagation angle of light in the H-film of each of the second film stacks, n_{2M} and d_{2M} are respectively a refractive index and physical thickness of the M-film of each of the second film stacks, θ_{2H} is a propagation angle of light in the M-film of each of the second film stacks, and λi is an use wavelength band that is a wavelength band of light incident on the multi-layer film.

An optical apparatus according to another aspect of the present invention includes the above optical element.

Further features and aspects of the present invention will become apparent from the following description of exemplary embodiments with reference to the attached drawings.

### BRIEF DESCRIPTION OF THE DRAWINGS

FIG. 1 is a schematic diagram illustrating a film configuration of an optical element according to embodiments of the present invention.

FIG. 2 is a chart illustrating an equivalent refractive index of the optical element according to a first embodiment.

FIG. 3 is a chart illustrating equivalent physical thickness of the optical element according to the first embodiment.

FIG. 4 is a chart illustrating values of conditional expressions (6) and (7) of SiO₂.

FIG. 5 is a chart illustrating refractive index dispersion of Ta₂O₅.

FIG. 6 is an equivalent refractive index of an optical element according to a second embodiment.

FIG. 7 is a chart illustrating equivalent physical thickness of the optical element according to the second embodiment.

FIG. 8 is a chart illustrating values of conditional expressions (6) and (7) according to the second embodiment.

FIG. 9 is a chart illustrating transmittance characteristics according to the second embodiment.

FIG. 10 is a schematic diagram illustrating a fluorescence microscope using the optical element according to the embodiments.

### DESCRIPTION OF THE EMBODIMENTS

Exemplary embodiments of the present invention will be described below with reference to the accompanied drawings.

First, common subject matters of first and second embodiments described below will be specifically explained. An optical element according to the embodiments includes a multi-layer film formed by repeatedly stacking a first film stack and a second film stack that are film stacks, where three or more films are stacked using two types of films (thin films) respectively made from materials having mutually different refractive indexes, and have mutually different film configurations.

FIG. 1 illustrates common configurations of the optical element according to the embodiments. An optical element 100 includes a substrate 101 and a multi-layer film formed by stacking a plurality of thin films 102-107. Of the thin films 102-107, the thin films 102-104 constitute a thin film stack 110 as the first film stack, and the thin films 105-107 constitute a thin film stack 120 as the second film stack.

Moreover, reference numeral 180 denotes incident light incident on the multi-layer film through an incident medium. In the embodiments, thin films mean films utilizing optical interference, and more particularly, films having optical thickness that is equal to or less than several times of an incident wavelength (use wavelength). Additionally, in the embodiments, a wavelength in a visible light range is used as the use wavelength, but a wavelength of other bandwidths may be used as the use wavelength.

In addition, FIG. 1 illustrates the configuration repeating only one stack of the thin film stacks 110 and 120 so as to simplify an illustration, but the embodiments characterize repeating a plurality of stacks of the thin film stacks 110 and 120. The number of repetitions is, for example, 5-200 times and differs depending on the configurations of the thin film stacks 110 and 120.

As described above, each thin film stack is formed by stacking three or more films using two types of thin films respectively made from materials having mutually different refractive indexes, but a thin film other than the two types of thin films may be extrapolated in each thin film stack.

In each of the thin film stacks 110 and 120, of the two types of thin films, a film formed of a material having a higher refractive index is an H-film and a film formed of a material having a lower refractive index is an M-film. The thin film stack (first film stack) 110 includes the H-film 102, the M-film 103 and the H-film 104 in this order, in other words, in the order of the H-film, the M-film and the H-film. Furthermore, the thin film stack (second film stack) 120 includes the M-film 105, the H-film 106 and the M-film 107 in this order, in other words, in the order of the M-film, the H-film and the M-film.

In each of the thin film stacks (first and second film stacks) 110 and 120, in other words, the same thin film stack, materials of the two H-films or the two M-films are desirably identical to each other. However, among the different thin film stacks, at least one of materials of the H-films or the M-films may differ from each other. Thus, the H-films 102 and 104 are desirably formed of the same materials, but the H-films 102 and 104 and the H-film 106 may be formed of the same materials or different materials. Similarly, the M-film 103 and the M-films 105 and 107 are desirably formed of the same materials, but the M-film 103 and the M-films 105 and 107 may be formed of the same materials or different materials.

Besides, in each of the thin film stacks 110 and 120 according to the embodiments, differences of physical thickness between the same two thin films (between the H-films 102 and 104 or the M-films 105 and 107) are desirably equal to or less than 10 nm. Such two thin films can be treated as one film referred to as an equivalent film. A refractive index n_{T} and physical thickness d_{T} of the equivalent film can be calculated by the following expressions (1) to (5).

$$\begin{matrix}{U}_{T}^{2} = {U}_{1}^{2} \frac{2 {U}_{1} {U}_{2} tan {Δ}_{1} + {U}_{2}^{2} tan {Δ}_{2} - {U}_{1}^{2} {tan}^{2} {Δ}_{1} tan {Δ}_{2}}{2 {U}_{1} {U}_{2} tan {Δ}_{1} + {U}_{1}^{2} tan {Δ}_{2} - {U}_{2}^{2} {tan}^{2} {Δ}_{1} tan {Δ}_{2}} & ( 1 ) \\ sin {Δ}_{T} = {U}_{T} ( \frac{2}{{U}_{1}} cos {Δ}_{1} sin {Δ}_{1} cos {Δ}_{2} + \frac{{U}_{1}^{2} {cos}^{2} {Δ}_{1} - {U}_{2}^{2} {sin}^{2} {Δ}_{1}}{{U}_{1}^{2} {U}_{2}} sin {Δ}_{2} ) & ( 2 ) \\ cos {Δ}_{T} = {cos}^{2} {Δ}_{1} cos {Δ}_{2} - {sin}^{2} {Δ}_{1} cos {Δ}_{2} - \frac{{U}_{1}^{2} + {U}_{2}^{2}}{{U}_{1} {U}_{2}} cos {Δ}_{1} sin {Δ}_{1} sin {Δ}_{2} & ( 3 ) \\ {U}_{T , 1 , 2} = \{ \begin{matrix}{n}_{T , 1 , 2} cos {θ}_{T , 1 , 2} & S polarization \\ \frac{{n}_{T , 1 , 2}}{cos {θ}_{T , 1 , 2}} & P polarization\end{matrix} & ( 4 ) \\ {Δ}_{T , 1 , 2} = \frac{2 π}{{λ}_{i}} {n}_{T , 1 , 2} {d}_{T , 1 , 2} cos {θ}_{T , 1 , 2} & ( 5 )\end{matrix}$$

In the above expressions (1) to (5), n is a refractive index, d is physical thickness, θ is an angle (propagation angle) of light propagating in a film, and the angle θ can be obtained from Snell's law and an incident angle of light. The incident angle is an angle of light incident to the thin film 107 being the outmost surface of the multi-layer film of the optical element 100 and is a central incident angle of the incident light. The left-side value of the expression (5) is a quantity referred to as phase thickness of each thin film.

Subscripts of variables in the expressions (1) to (5) represent the thin films, and the number “1” is the H-films 102 and 104 of the thin film stack 110 and the M-films 105 and 107 of the thin film stack 120. The number “2” is the thin film arranged at a middle position among each thin film stack, in other words, the M-film 103 of the thin film stack 110 and the H-film 106 of the thin film stack 120. Assigning the variables U_{1,2} and Δ_{1,2} converted from the refractive indexes n₁ and n₂ and the physical thickness d₁ and d₂ of each thin film using the expressions (4) and (5) to the expressions (1) to (3) obtains the variables U_{T} and Δ_{T}, and the equivalent refractive index n_{T} and the equivalent physical thickness d_{T} can be calculated from the variables U_{T} and Δ_{T}.

### First Embodiment

An optical element 100 according to a first embodiment 1 will be explained. Table 1 provides specific film configurations of thin film stacks 110 and 120. In this embodiment, H-films j (j represents a material) 102, j104 and j106 are formed of Ta₂O₅, and M-films j103, j105 and j107 are formed of MgF₂. The stack of the thin film stacks 110 and 120 are repeated thirty times.

TABLE 1

| | | wavelength | physical | film |
|---|---|---|---|---|
| | film | n | thickness [nm] | configuration |
| j1i | white board | 1.530 | — | |
| j107 | SiO₂ | 1.472 | 28.6 | ×30 |
| j106 | Ta₂O₅ | 2.209 | 16.9 | |
| j105 | SiO₂ | 1.472 | 28.6 | |
| j104 | Ta₂O₅ | 2.209 | 12.6 | |
| j103 | SiO₂ | 1.472 | 44.3 | |
| j102 | Ta₂O₅ | 2.209 | 12.6 | |
| j101 | white board | 1.530 | — | |

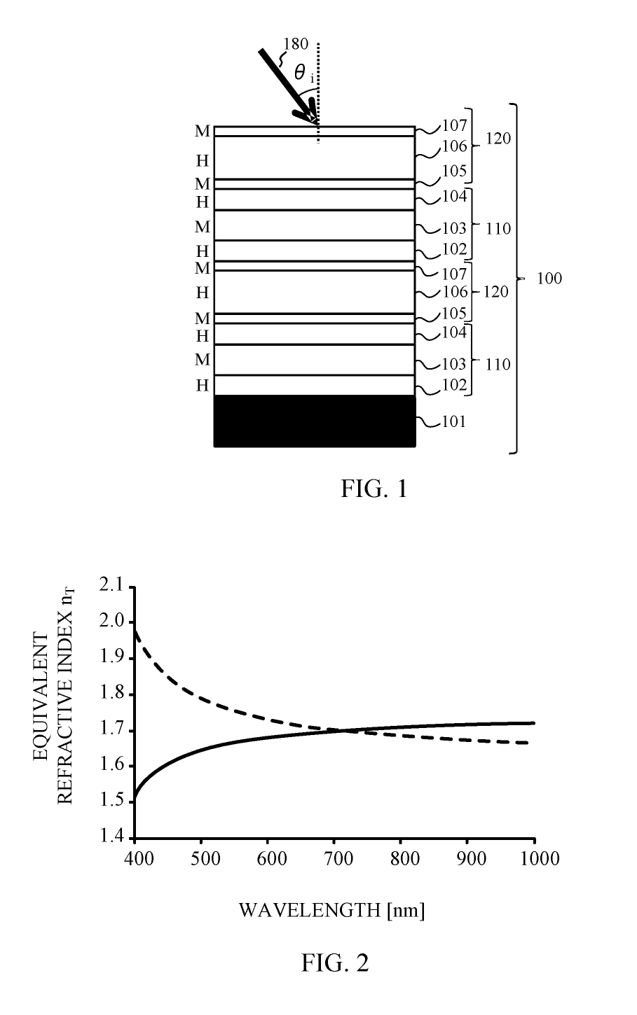

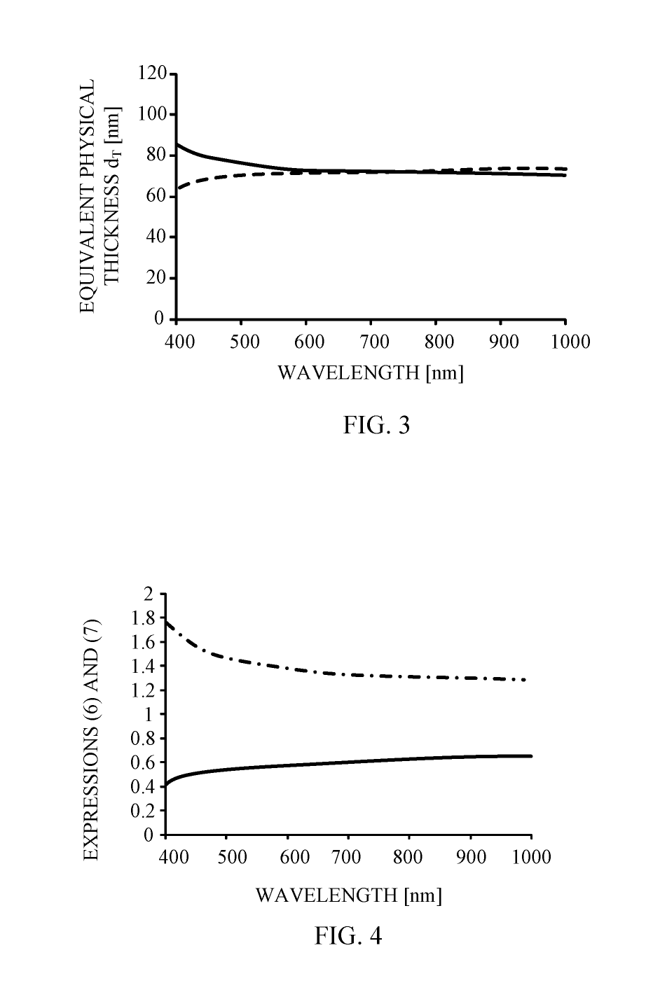

FIGS. 2 and 3 respectively illustrate an equivalent refractive index n_{T} and equivalent physical thickness d_{T} of the thin film stacks 110 and 120 for each wavelength of incident light incident at an incident angle of 0° in this embodiment. In FIGS. 2 and 3, solid lines are respectively the equivalent refractive index and the equivalent physical thickness of the films j102 to j104 constituting the thin film stack 110, and broken lines are respectively the equivalent refractive index and the equivalent physical thickness of the films j105 to j107 constituting the thin film stack 120.

In this embodiment, the H-films j102 and j104 and the H-film 106 are formed of the same materials (Ta₂O₅), but may be formed of different materials. Similarly, the M-film 103 and the M-films j105 and j107 are formed of the same materials (MgF₂), but may be formed of different materials.

Herein, n_{1H} and d_{1H} are respectively a refractive index and physical thickness of the H-films (j102 and j104) of the thin film stack 110, and θ_{1H} is a propagation angle of light in the H-films, n_{1M} and d_{1M} are respectively a refractive index and physical thickness of the M-film (j103) of the thin film stack 110, and θ_{1M} is a propagation angle of light in the M-film. Additionally, n_{2H} and d_{2H} are respectively a refractive index and physical thickness of the H-film (j106) of the thin film stack 120, and θ_{2H} is a propagation angle of light in the H-film, n_{2M} and d_{2M} are respectively a refractive index and physical thickness of the M-films (j105 and j107) of the thin film stack 120, and θ_{2M} is a propagation angle of light in the H-films. Further, an use wavelength band λi is a wavelength band of light incident to a multi-layer film. The multi-layer film according to this embodiment satisfies the following conditional expressions (6) and (7).

$$\begin{matrix}\frac{\begin{matrix}2 {U}_{1 H} {U}_{1 M} tan {Δ}_{1 H} + {U}_{1 M}^{2} tan {Δ}_{1 M} - \\ {U}_{1 H}^{2} {tan}^{2} {Δ}_{1 H} tan {Δ}_{1 M}\end{matrix}}{\begin{matrix}2 {U}_{1 H} {U}_{1 M} tan {Δ}_{1 H} + {U}_{1 H}^{2} tan {Δ}_{1 M} - \\ {U}_{1 M}^{2} {tan}^{2} {Δ}_{1 H} tan {Δ}_{1 M}\end{matrix}} > 0 & ( 6 ) \\ \frac{\begin{matrix}2 {U}_{2 H} {U}_{2 M} tan {Δ}_{2 H} + {U}_{2 M}^{2} tan {Δ}_{2 M} - \\ {U}_{2 H}^{2} {tan}^{2} {Δ}_{2 H} tan {Δ}_{2 M}\end{matrix}}{\begin{matrix}2 {U}_{2 H} {U}_{2 M} tan {Δ}_{2 H} + {U}_{2 H}^{2} tan {Δ}_{2 M} - \\ {U}_{2 M}^{2} {tan}^{2} {Δ}_{2 H} tan {Δ}_{2 M}\end{matrix}} > 0 & ( 7 ) \\ {U}_{1 H , 1 M , 2 H , 2 M} = {n}_{1 H , 1 M , 2 H , 2 M} cos {θ}_{1 H , 1 M , 2 H , 2 M} & ( 8 ) \\ {Δ}_{1 H , 1 M , 2 H , 2 M} = \frac{2 π}{{λ}_{i}} {n}_{1 H , 1 M , 2 H , 2 M} {d}_{1 H , 1 M , 2 H , 2 M} cos {θ}_{1 H , 1 M , 2 H , 2 M} & ( 9 )\end{matrix}$$

FIG. 4 illustrates values of the expressions (6) and (7) respectively regarding the thin film stacks 110 and 120 for each wavelength when the use wavelength band λi is a wavelength of 400 to 1000 nm. In FIG. 4, the solid line is the value of the expression (6), and the dashed-dotted line is the value of the expression (7). The thin film stacks 110 and 120 respectively satisfy the conditions of the expressions (6) and (7). When the conditions of the expressions (6) and (7) fails to be satisfied, the thin film stacks 110 and 120 cannot approximate an equivalent film as evident from the expression (1). Such thin films have entirely different property for each wavelength and thus, are undesirable.

Moreover, in this embodiment, the following conditional expression (10) is satisfied at either wavelength λ₁ in the use wavelength band λi of the optical element 100.

$$\begin{matrix}\vert \begin{matrix}{U}_{1 H}^{2} \frac{\begin{matrix}2 {U}_{1 H} {U}_{1 M} tan {Δ}_{1 H 1} + {U}_{1 M}^{2} tan {Δ}_{1 M 1} - \\ {U}_{1 H}^{2} {tan}^{2} {Δ}_{1 H} tan {Δ}_{1 M 1}\end{matrix}}{\begin{matrix}2 {U}_{1 H} {U}_{1 M} tan {Δ}_{1 H 1} + {U}_{1 H}^{2} tan {Δ}_{1 M 1} - \\ {U}_{1 M}^{2} {tan}^{2} {Δ}_{1 H} tan {Δ}_{1 M 1}\end{matrix}} - \\ {U}_{2 M}^{2} \frac{\begin{matrix}2 {U}_{2 H} {U}_{2 M} tan {Δ}_{2 M 1} + {U}_{2 M}^{2} tan {Δ}_{2 H 1} - \\ {U}_{2 H}^{2} {tan}^{2} {Δ}_{2 M 1} tan {Δ}_{2 H 1}\end{matrix}}{\begin{matrix}2 {U}_{2 H} {U}_{2 M} tan {Δ}_{2 M 1} + {U}_{2 H}^{2} tan {Δ}_{2 H 1} - \\ {U}_{2 M}^{2} {tan}^{2} {Δ}_{2 H 1} tan {Δ}_{2 H 1}\end{matrix}}\end{matrix} \vert < 0.05 & ( 10 ) \\ {Δ}_{1 H 1 , 1 M 1 , 2 H 1 , 2 M 1} = \frac{2 π}{{λ}_{1}} {n}_{1 H , 1 M , 2 H , 2 M} {d}_{1 H , 1 M , 2 H , 2 M} cos {θ}_{1 H , 1 M , 2 H , 2 M} & ( 11 )\end{matrix}$$

The expression (10) defines a condition regarding differences between values of the expression (1) of the thin film stacks 110 and 120 at the wavelength λ₁. In other words, the variables U_{T} of the thin film stacks 110 and 120 are close to each other. The left-side value of the expression (10) according to this embodiment can be calculated using the refractive index that is obtained from FIG. 2, and is 0 at the wavelength λ₁=700 nm.

As described above, the expression (10) is intended to lower refractive index differences between equivalent films formed of each of the thin film stacks 110 and 120. When the thin film stack is converted into the equivalent film, reflection on a boundary between films is not generated in a region where refractive indexes are the same. Accordingly, reflection at a wavelength of 700 nm is not generated on a boundary between the thin film stacks 110 and 120 according to this embodiment. Meanwhile, refractive index differences at a wavelength of 500 nm enlarge and thus, reflection on the boundary between the thin film stacks 110 and 120 widely occurs. As just described, satisfying the expression (10) can adjust the presence or absence of reflection in the use wavelength band using refractive index differences.

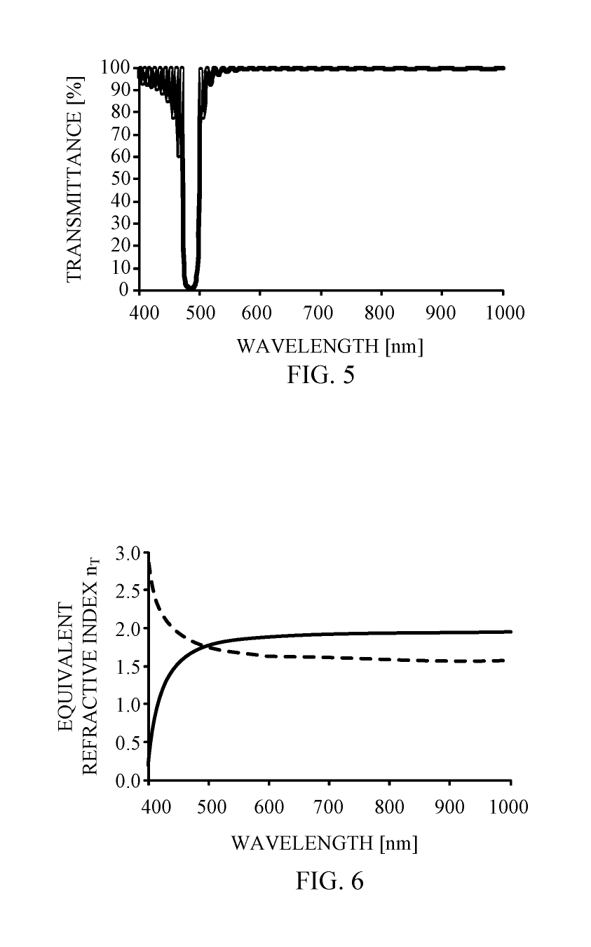

FIG. 5 illustrates transmittance of the optical element shown in table 1. As previously explained, transmittance at a wavelength of 700 nm, where reflection is low, is high, and transmittance near a wavelength of 500 nm, where refractive index differences (i.e., reflection) is big, significantly reduces. As just described, a film (filter) that has high transmittance in a wide wavelength band and reflects part of light in the wavelength band is regarded as a minus filter.

In addition, in the first embodiment, at a wavelength λ₂ different from the wavelength λ₁ in the use wavelength band λi, both of the following conditional expressions (12) and (13) are satisfied.

$$\begin{matrix}- 0.1 < {cos}^{2} {Δ}_{1 H 2} cos {Δ}_{1 M 2} - {sin}^{2} {Δ}_{1 H 2} cos {Δ}_{1 M 2} - \frac{{U}_{1 H}^{2} + {U}_{1 M}^{2}}{{U}_{1 H} {U}_{1 M}} cos {Δ}_{1 H 2} sin {Δ}_{1 H 2} sin {Δ}_{1 M 2} < 0.1 & ( 12 ) \\ - 0.1 < {cos}^{2} {Δ}_{2 M 2} cos {Δ}_{2 H 2} - {sin}^{2} {Δ}_{2 M 2} cos {Δ}_{2 H 2} - \frac{{U}_{2 H}^{2} + {U}_{2 M}^{2}}{{U}_{2 H} {U}_{2 M}} cos {Δ}_{2 M 2} sin {Δ}_{2 M 2} sin {Δ}_{2 H 2} < 0.1 & ( 13 ) \\ {Δ}_{1 H 2 , 1 M 2 , 2 H 2 , 2 M 2} = \frac{2 π}{{λ}_{2}} {n}_{1 H , 1 M , 2 H , 2 M} {d}_{1 H , 1 M , 2 H , 2 M} cos {θ}_{1 H , 1 M , 2 H , 2 M} & ( 14 )\end{matrix}$$

In this embodiment, values of mechanical expression parts of the expressions (12) and (13) are 0 at a wavelength of 500 nm.

As has been explained above, at the wavelength λ₁=700 nm, refractive index differences between the equivalent films is small and thus, reflection at a boundary between the thin films is not generated. However, at the wavelength λ₂=500 nm, making optical thickness (n_{T}×d_{T}), which is the product of the equivalent refractive index n_{T} and the equivalent physical thickness d_{T} of the thin film stacks 110 and 120, λ/4 is effective to increase reflection.

The expressions (12) and (13) expresses a range where the optical thickness of the thin film stacks 110 and 120 is λ/4, in other words, the phase thickness is an odd multiple of 90°. Satisfying the expressions effectively increase reflection at a wavelength of 500 nm.

Further, total thickness of the multi-layer film according to this embodiment is extremely as thick as about 5 μm. Furthermore, repeatedly stacking the same thin films j101 to j107 enables the multi-layer film according to this embodiment to be manufactured very easily.

### Second Embodiment

An optical element 100 according to a second embodiment will be explained. Table 2 provides specific film configurations of thin film stacks 110 and 120. In this embodiment, H-films j102, j104 and j106 are formed of Ta₂O₅ and M-films j103, j105 and j107 are formed of MgF₂. The stack of the thin film stacks 110 and 120 are repeated forty times.

TABLE 2

| | | wavelength | physical | film |
|---|---|---|---|---|
| | film | n | thickness [nm] | configuration |
| j1i | white board | 1.530 | — | |
| j107 | SiO₂ | 1.472 | 50.2 | ×40 |
| j106 | Ta₂O₅ | 2.209 | 11.6 | |
| j105 | SiO₂ | 1.472 | 50.2 | |
| j104 | Ta₂O₅ | 2.209 | 31.3 | |
| j103 | SiO₂ | 1.472 | 24.8 | |
| j102 | Ta₂O₅ | 2.209 | 31.3 | |
| j101 | white board | 1.530 | — | |

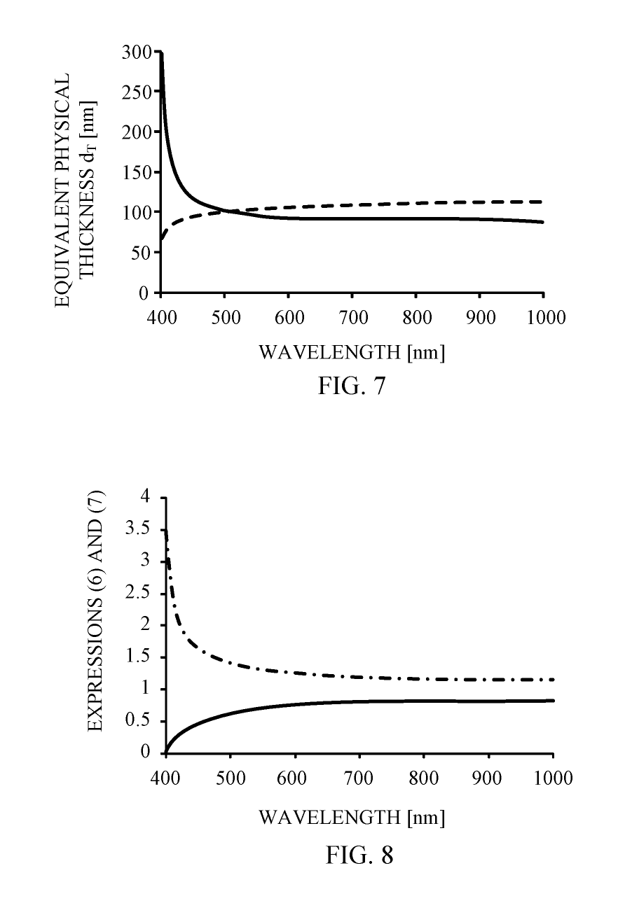

FIGS. 6 and 7 respectively illustrate an equivalent refractive index n_{T} and equivalent physical thickness d_{T} of the thin film stacks 110 and 120 for each wavelength of incident light incident at an incident angle of 0° in this embodiment. In FIGS. 6 and 7, solid lines are respectively the equivalent refractive index and the equivalent physical thickness of the films j102 to j104 constituting the thin film stack 110, and broken lines are respectively the equivalent refractive index and the equivalent physical thickness of the films j105 to j107 constituting the thin film stack 120.

In this embodiment, the H-films j102 and j104 and the H-film 106 are formed of the same materials (Ta₂O₅), but may be formed of different materials. Similarly, the M-film 103 and the M-films j105 and j107 are formed of the same materials (MgF₂), but may be formed of different materials.

FIG. 8 illustrates values of the expressions (6) and (7) respectively regarding the thin film stacks 110 and 120 for each wavelength when the use wavelength band λi is a wavelength of 400 to 1000 nm. In FIG. 8, the solid line is the value of the expression (6), and the dashed-dotted line is the value of the expression (7). The thin film stacks 110 and 120 respectively satisfy the conditions of the expressions (6) and (7).

Besides, as illustrated in FIG. 6, the equivalent refractive indexes n_{T} of the thin film stacks 110 (j102 to j104) and 120 (j105 to j107) intersect at a wavelength of 500 nm. Accordingly, the value of the expression (10) is 0 at the wavelength λ₁=500 nm and thus, satisfies the condition of the expression (10). In FIG. 6, the equivalent refractive index n_{T} of the thin film stack 110 (j102 to j104) is equal to or less than 1 near a wavelength of 400 nm. Though a wavelength band narrows, characteristics that is not realized in equivalent films can be obtained.

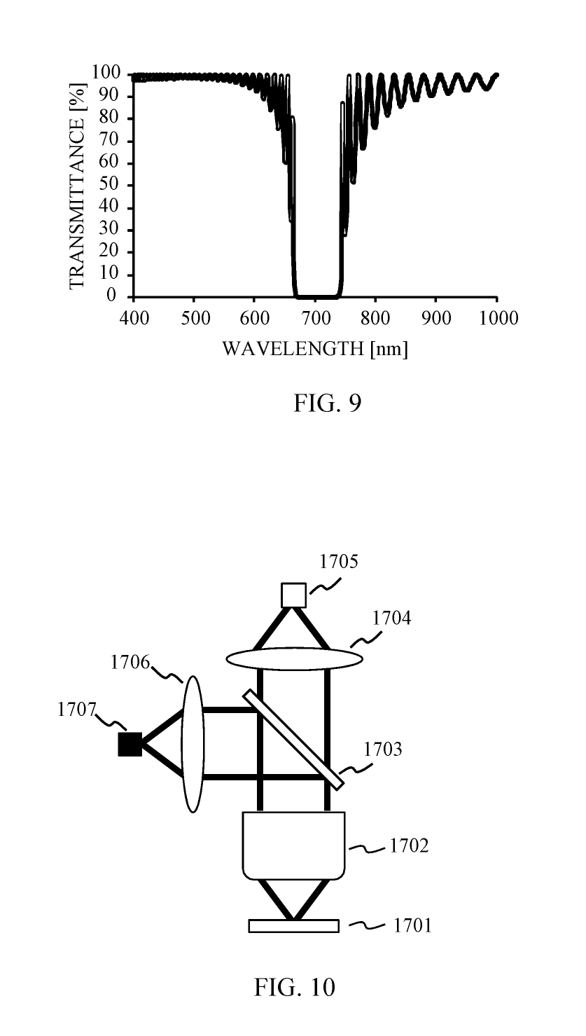

FIG. 9 illustrates transmittance characteristics according to this embodiment. The optical element 100 according to this embodiment has characteristics as a minus filter that reflection at a wavelength of 700 nm is high and transmittance at the other wavelength bands is high. Additionally, in this embodiment, both values of mechanical expression parts of the expressions (12) and (13) are 0 at the wavelength λ₂=700 nm and thus, both conditions of the expressions (12) and (13) are satisfied.

Total thickness of the multi-layer film according to this embodiment is extremely as thick as about 8 μm. Moreover, repeatedly stacking the same thin films j101 to j107 enables the multi-layer film according to this embodiment to be manufactured very easily.

In the case of using a plurality of thin films are used, when the plurality of thin films have equivalent interference characteristics, each of optical thickness and refractive index of the plurality of thin films may not completely accord, and may have differences within a certain degree of an acceptable range. Specifically, at an use central wavelength, the acceptable range of the refractive index and the optical thickness are respectively within the range of approximately ±0.02 in and within the range of not higher than of 1/20.

### Third Embodiment

FIG. 10 illustrates a configuration of a fluorescence microscope as an example of optical apparatuses using the optical element 100 according to the first and second embodiments. Reference numeral 1701 denotes an object (sample), and 1702 an objective lens. Reference numerals 1704 and 1706 denote condenser lenses, and 1705 light detection element. Reference numeral 1707 denotes a light emitting element. And reference numeral 1703 denotes an optical element having a minus filter function explained in either of the first and second embodiments.

The condenser lens 1706 converts light from the light emitting element 1707 into parallel light, and the converted light enters the optical element 1703. The optical element 1703 has a function that reflects the light incident from the light emitting element 1707, and the reflected light by the optical element 1703 is focused onto the sample 1701 through the objective lens 1702.

Fluorescence generated by the light focused onto the sample 1701 is converted into parallel light through the objective lens 1702, and enters the optical element 1703. The fluorescence is light having a wavelength different from a wavelength of the incident light from the light emitting element 1707. Herein, a film configuration of a multi-layer film of the optical element 1703 is set so that a wavelength of the fluorescence is a transmissive wavelength band. The fluorescence transmitting the optical element 1703 is focused onto the light detection element 1705 through the condenser lens 1704, and is detected by the light detection element 1705.

When the optical element 1703 is arranged to tilt at 45° as explained in this embodiment, optical thickness of each thin film may be set for 45°, and when the optical element 1703 is arranged to tilt at the other angle, optical thickness of each thin film may be naturally set for the other angle.

In addition, the optical element according to each embodiment is can be applied not only to the fluorescence microscope but also to various optical apparatuses requiring a filter function to selectively perform reflection and transmission according to a wavelength of incident light.

According to each embodiment, the optical element capable of obtaining a favorable optical performance similar to minus filters while suppressing total thickness of a multi-layer film can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-122940, filed on Jun. 18, 2015, which is hereby incorporated by reference herein in its entirety.

What is claimed is:

1. An optical element comprising:
a multi-layer film formed by stacking a plurality of first film stacks and second film stacks that are film stacks, where three or more films are stacked using two types of films respectively made from materials having mutually different refractive indexes, and have different film configurations,
wherein when, of the two types of films in the plurality of first and second film stacks, a film made from a material having a higher refractive index is an H-film and a film made from a material having a lower refractive index is an M-film,
the H-film and the M-film of each of the first film stacks are stacked in the order of the H-film, the M-film and the H-film, and
the H-film and the M-film of each of the second film stacks are stacked in the order of the M-film, the H-film and the M-film, and
wherein the following conditional expression are satisfied:
$$\frac{2 {U}_{1 H} {U}_{1 M} tan {Δ}_{1 H} + {U}_{1 M}^{2} tan {Δ}_{1 M} - {U}_{1 H}^{2} {tan}^{2} {Δ}_{1 H} tan {Δ}_{1 M}}{2 {U}_{1 H} {U}_{1 M} tan {Δ}_{1 H} + {U}_{1 H}^{2} tan {Δ}_{1 M} - {U}_{1 M}^{2} {tan}^{2} {Δ}_{1 H} tan {Δ}_{1 M}} > 0$$
$$\frac{2 {U}_{2 H} {U}_{2 M} tan {Δ}_{2 H} + {U}_{2 M}^{2} tan {Δ}_{2 M} - {U}_{2 H}^{2} {tan}^{2} {Δ}_{2 H} tan {Δ}_{2 M}}{2 {U}_{2 H} {U}_{2 M} tan {Δ}_{2 H} + {U}_{2 H}^{2} tan {Δ}_{2 M} - {U}_{2 M}^{2} {tan}^{2} {Δ}_{2 H} tan {Δ}_{2 M}} > 0$$
$${U}_{1 H , 1 M , 2 H , 2 M} = {n}_{1 H , 1 M , 2 H , 2 M} cos {θ}_{1 H , 1 M , 2 H , 2 M}$$
$${Δ}_{1 H , 1 M , 2 H , 2 M} = \frac{2 π}{{λ}_{i}} {n}_{1 H , 1 M , 2 H , 2 M} {d}_{1 H , 1 M , 2 H , 2 M} cos {θ}_{1 H , 1 M , 2 H , 2 M} ,$$
where n_{1H} and d_{1H} are respectively a refractive index and physical thickness of the H-film of each of the first film stacks, θ_{1H} is a propagation angle of light in the H-film of each of the first film stacks, n_{1M} and d_{1M} are respectively a refractive index and physical thickness of the M-film of each of the first film stacks, θ_{1M} is a propagation angle of light in the M-film of each of the first film stacks, n_{2H} and d_{2H} are respectively a refractive index and physical thickness of the H-film of each of the second film stacks, θ_{2H} is a propagation angle of light in the H-film of each of the second film stacks, n_{2M} and d_{2M} are respectively a refractive index and physical thickness of the M-film of each of the second film stacks, θ_{2H} is a propagation angle of light in the M-film of each of the second film stacks, and λi is an use wavelength band that is a wavelength band of light incident on the multi-layer film.

2. The optical element according to claim 1, wherein at least one of materials of the H-films of the first and second film stacks or the M-films of the first and second film stacks differs from each other.

3. The optical element according to claim 3, wherein a wavelength λ₁ in the use wavelength band λᵢ satisfies the following conditional expressions:
$$\vert \begin{matrix}{U}_{1 H}^{2} \frac{\begin{matrix}2 {U}_{1 H} {U}_{1 M} tan {Δ}_{1 H 1} + {U}_{1 M}^{2} tan {Δ}_{1 M 1} - \\ {U}_{1 H}^{2} {tan}^{2} {Δ}_{1 H} tan {Δ}_{1 M 1}\end{matrix}}{\begin{matrix}2 {U}_{1 H} {U}_{1 M} tan {Δ}_{1 H 1} + {U}_{1 H}^{2} tan {Δ}_{1 M 1} - \\ {U}_{1 M}^{2} {tan}^{2} {Δ}_{1 H} tan {Δ}_{1 M 1}\end{matrix}} - \\ {U}_{2 M}^{2} \frac{\begin{matrix}2 {U}_{2 H} {U}_{2 M} tan {Δ}_{2 M 1} + {U}_{2 M}^{2} tan {Δ}_{2 H 1} - \\ {U}_{2 H}^{2} {tan}^{2} {Δ}_{2 M 1} tan {Δ}_{2 H 1}\end{matrix}}{\begin{matrix}2 {U}_{2 H} {U}_{2 M} tan {Δ}_{2 M 1} + {U}_{2 H}^{2} tan {Δ}_{2 H 1} - \\ {U}_{2 M}^{2} {tan}^{2} {Δ}_{2 H 1} tan {Δ}_{2 H 1}\end{matrix}}\end{matrix} \vert < 0.05$$
$${Δ}_{1 H 1 , 1 M 1 , 2 H 1 , 2 M 1} = \frac{2 π}{{λ}_{1}} {n}_{1 H , 1 M , 2 H , 2 M} {d}_{1 H , 1 M , 2 H , 2 M} cos {θ}_{1 H , 1 M , 2 H , 2 M} .$$

4. The optical element according to claim 1, wherein, in the first and second film stacks, differences between physical thicknesses of the same type of two films is equal to or less than 10 nm.

5. The optical element according to claim 1, wherein a wavelength λ₂ different from the wavelength λₗ in the use wavelength band λᵢ satisfies the following conditional expressions:
$$- 0.1 < {cos}^{2} {Δ}_{1 H 2} cos {Δ}_{1 M 2} - {sin}^{2} {Δ}_{1 H 2} cos {Δ}_{1 M 2} - \frac{{U}_{1 H}^{2} + {U}_{1 M}^{2}}{{U}_{1 H} {U}_{1 M}} cos {Δ}_{1 H 2} sin {Δ}_{1 H 2} sin {Δ}_{1 M 2} < 0.1 \\ - 0.1 < {cos}^{2} {Δ}_{2 M 2} cos {Δ}_{2 H 2} - {sin}^{2} {Δ}_{2 M 2} cos {Δ}_{2 H 2} - \frac{{U}_{2 H}^{2} + {U}_{2 M}^{2}}{{U}_{2 H} {U}_{2 M}} cos {Δ}_{2 M 2} sin {Δ}_{2 M 2} sin {Δ}_{2 H 2} < 0.1$$
$${Δ}_{1 H 2 , 1 M 2 , 2 H 2 , 2 M 2} = \frac{2 π}{{λ}_{2}} {n}_{1 H , 1 M , 2 H , 2 M} {d}_{1 H , 1 M , 2 H , 2 M} cos {θ}_{1 H , 1 M , 2 H , 2 M}$$

6. An optical apparatus comprising:
an optical element including a multi-layer film formed by stacking a plurality of first film stacks and second film stacks that are film stacks, where three or more films are stacked using two types of films made from materials mutually refractive indexes, and have different film configurations,
wherein when, of the two types of films in the plurality of first and second film stacks, a film made from a material having a higher refractive index is an H-film and a film made from a material having a lower refractive index is a M-film,
the H-film and the M-film of each of the first film stacks are stacked in the order of the H-film, the M-film and the H-film, and
the H-film and the M-film of each of the second film stacks are stacked in the order of the M-film, the H-film and the M-film, and
wherein the following conditional expression is satisfied:
$$\frac{2 {U}_{1 H} {U}_{1 M} tan {Δ}_{1 H} + {U}_{1 M}^{2} tan {Δ}_{1 M} - {U}_{1 H}^{2} {tan}^{2} {Δ}_{1 H} tan {Δ}_{1 M}}{2 {U}_{1 H} {U}_{1 M} tan {Δ}_{1 H} + {U}_{1 H}^{2} tan {Δ}_{1 M} - {U}_{1 M}^{2} {tan}^{2} {Δ}_{1 H} tan {Δ}_{1 M}} > 0$$
$$\frac{2 {U}_{2 H} {U}_{2 M} tan {Δ}_{2 H} + {U}_{2 M}^{2} tan {Δ}_{2 M} - {U}_{2 H}^{2} {tan}^{2} {Δ}_{2 H} tan {Δ}_{2 M}}{2 {U}_{2 H} {U}_{2 M} tan {Δ}_{2 H} + {U}_{2 H}^{2} tan {Δ}_{2 M} - {U}_{2 M}^{2} {tan}^{2} {Δ}_{2 H} tan {Δ}_{2 M}} > 0$$
$${U}_{1 H , 1 M , 2 H , 2 M} = {n}_{1 H , 1 M , 2 H , 2 M} cos {θ}_{1 H , 1 M , 2 H , 2 M}$$
$${Δ}_{1 H , 1 M , 2 H , 2 M} = \frac{2 π}{{λ}_{i}} {n}_{1 H , 1 M , 2 H , 2 M} {d}_{1 H , 1 M , 2 H , 2 M} cos {θ}_{1 H , 1 M , 2 H , 2 M} ,$$
where n_{1H} and d_{1H} are respectively a refractive index and physical thickness of the H-film of each of the first film stacks, θ_{1H} is a propagation angle of light in the H-film of each of the first film stacks, n_{1M} and d_{1M} are respectively a refractive index and physical thickness of the M-film of each of the first film stacks, θ_{1M} is a propagation angle of light in the M-film of each of the first film stacks, n_{2H} and d_{2H} are respectively a refractive index and physical thickness of the H-film of each of the second film stacks, θ_{2H} is a propagation angle of light in the H-film of each of the second film stacks, n_{2M} and d_{2M} are respectively a refractive index and physical thickness of the M-film of each of the second film stacks, θ_{2H} is a propagation angle of light in the M-film of each of the second film stacks, and λi is an use wavelength band that is a wavelength band of light incident on the multi-layer film.
